(19) United States
(12) Patent Application Publication
(10) Pub. No.: US 2006/0020883 A1
(43) Pub. Date: Jan. 26, 2006

(54) Web page personalization

(75) Inventors: Nikhil Kothari, Sammamish, WA (US); Michael J. Harder, Bellevue, WA (US); Robert M. Howard, Frisco, TX (US); Andres M. Sanabria, Sammamish, WA (US); Stefan N. Schackow, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 10/857,724

(22) Filed: May 28, 2004

(51) Int. Cl. G06F 17/21; G06F 17/24; G06F 15/16

(52) U.S. Cl. 715/513; 715/530; 709/203

(57) ABSTRACT

Web pages may be dynamically generated in response to a web request from a client. The web request specifies a dynamic content resource that declares one or more server-side controls having personalizable properties. Personalization refers to the ability for server-side controls to save property values to persistent storage and is not necessarily limited to a user-specific data management. Personalization also refers to retrieving the property values from persistent storage when the server-side controls are instantiated in order to dynamically generate the web page reflecting the persistent personalization data. The personalized property values may also be output with the HTML data of the resulting page and sent to the client for display.

### TECHNICAL FIELD

The invention relates generally to a user interface framework, and more particularly to web page personalization or customization.

### BACKGROUND

A typical web browser receives data from a web server that defines the appearance and rudimentary behavior of a web page for display on a client system. In a typical scenario, a user specifies a Uniform Resource Identifier (“URI”), which represents a global address of a resource on the World Wide Web, to access a desired web site. Generally, the term “resource” refers to data and/or routines that can be accessed by a program. A browser generates an HTTP (HyperText Transport Protocol) request directed to the specified address to retrieve data associated with the resource. A web server hosting the resource receives the HTTP request and returns the requested web page or other resource data in an HTTP response to the client system for use (e.g., display) in the browser.

Typically, a web page includes static HTML (HyperText Markup Language) code or some other authoring language data. HTML is a plain-text authoring language used to create documents (e.g., web pages) on the World Wide Web. As such, an HTML file can be received from a web server and displayed as a web page in a browser. Using HTML, a developer can, for example, specify formatted text, lists, forms, tables, hypertext links, inline images and sounds, and background graphics for display in the browser to present the rich graphical experience that users have come to expect while viewing information from the Internet. An HTML file, however, is a static file that does not inherently support dynamic generation of web page content.

If dynamic content is to be displayed, such as a changing stock price or traffic information, a server-side application program is often developed to handle the more complex client-server interaction. The server-side application program processes an HTTP request and generates the appropriate HTML code for transmission to the client in an HTTP response. However, developing a server-side application program can be a complex programming task.

One approach to minimize the server-side programming requirements of dynamic web page generation has involved server-side controls (e.g., server controls, user controls) specified by an HTML-like style of declarative programming. Server-side control declarations are provided in a dynamic content file. Based on such server-side control declarations, the specified server controls are executed on the server to provide the functionality of client-side user interface elements (e.g., buttons, text boxes, etc.). The server controls can process postback input data and events, manage state, bind to backend data, and render HTML output that is transmitted to the client for display as a web page in a browser. However, existing approaches do not directly support persistence of personalized data, such as a user's zip code that is input by the user through the browser. In the existing approaches, such personalized data is not persistent or a developer provides the custom programming required to persist the data.

### SUMMARY

Implementations described and claimed herein address the foregoing problems by processing a dynamic content resource that declares one or more server-side controls having personalizable properties. Server-side controls can save property values of these personalizable properties to persistent storage. Therefore, personalizable property values can also be retrieved from persistent storage when the server-side controls are instantiated in order to dynamically generate the web page reflecting the persistent personalization data. The personalized property values may also be output with the authoring language data of the resulting page and sent to the client for display.

In some implementations, articles of manufacture are provided as computer program products. One implementation of a computer program product provides a computer program storage medium readable by a computer system and encoding a computer program. Another implementation of a computer program product may be provided in a computer data signal embodied in a carrier wave by a computing system and encoding the computer program.

The computer program product encodes a computer program for a computer process executing on a computer system. The computer process personalizes a web page using a server-side control at a web server, responsive to a receipt of a request from a client. The request specifies a dynamic content resource containing a declaration of the server-side control. Personalization data associated with the server-side control is extracted from a persistent personalization datastore. The server-side control is created at the web server based on the declaration. The personalization data is loaded into the server-side control. Authoring language data defining the personalized web page that includes the personalization data associated with the server-side control is generated from the server-side control.

In another implementation, a method is provided that personalizes a web page using a server-side control at a web server, responsive to a receipt of a request from a client. The request specifies a dynamic content resource containing a declaration of the server-side control. Personalization data associated with the server-side control is extracted from a persistent personalization datastore. The server-side control is created at the web server based on the declaration. The personalization data is loaded into the server-side control. Authoring language data defining the personalized web page that includes the personalization data associated with the server-side control is generated from the server-side control.

In another implementation, a web server for personalizing a web page using a server-side control at a web server, responsive to a receipt of a request from a client, is provided. The request specifies a dynamic content resource containing a declaration of the server-side control. A provider module extracts from a persistent personalization datastore personalization data associated with the server-side control. A page factory instantiates the server-side control at the web server based on the declaration. A personalization loading module loads the personalization data into the server-side control. A rendering module generates from the server-side control authoring language data defining the personalized web page that includes the personalization data associated with the server-side control.

Other implementations are also described and recited herein.

### BRIEF DESCRIPTIONS OF THE DRAWINGS

FIG. 1 illustrates an exemplary web server for dynamically generating web page content with persistent personalized data.

FIG. 2 illustrates exemplary modules supporting web page personalization in a web server.

FIG. 3 illustrates a process flow diagram representing server-side processing of an exemplary page object and other control objects.

FIG. 4 illustrates exemplary operations for personalizing server-side controls.

FIG. 5 illustrates an exemplary system useful for in implementations of the described technology.

### DETAILED DESCRIPTIONS

Web page content may be dynamically generated on a web server for display on a client. The client and the web server communicate across a network, for example, using HTTP requests and HTTP responses. The client requests data from a server resource, such as a dynamic web page file, and the web server generates the responsive web page content, typically in the form of HTML code. The web server then transmits the content to the client, which can display the web page in a browser. The web page typically includes client-side user interface elements, such as text boxes, grids, buttons, etc.

In one implementation, the HTML code used to define the client-side user interface elements in the HTTP response is generated by one or more server-side controls. A server-side control at the web server logically corresponds to a user interface element of the web page and is responsible for performing the functionality of the user interface element and for generating the HTML code used to display the element. After responding to the request, the server-side controls are terminated (i.e., their objects are deleted at the server), possibly to be re-instantiated in response to a subsequent request.

One type of server-side control is termed a “server control”. Built-in server controls are compiled and collected into a server control class library within the server environment. Server controls are declared as special tags in a dynamic content resource (e.g., a dynamic web page file) and are processed by the web server to provide the functionality of corresponding client-side user interface elements. In order to be available to the dynamic content resource, server controls are registered with the dynamic content resource by declaring the name of the compiled control class assembly that defines the server control, such as by using an exemplary declaration of the form:
<%@ Register TagPrefix=“ACME” NameSpace=“ACME.Controls” Assembly=“ACME.Controls” %>
   wherein “Acme.Controls” specifies the name of the compiled server control class assembly.

When a web server detects a server control tag in a specified dynamic content resource, the web server finds the corresponding server control in the server control class library and instantiates the corresponding control object in memory. This object can have properties and methods, and can expose or raise server events during the processing of the dynamic content resource. In some implementations, server controls can process postback input and events, manage the control's states, and bind to backend data. When the processing of the dynamic content resource is completed, each server control in the dynamic content resource emits its output in the form of HTML (or some other authoring language). The output is then sent to the browser as part of the resulting page.

In contrast, a “user control” is a different type of server-side control that is defined by a user-developer, rather than being distributed in compiled form with the server environment in a server control class library. Exemplary user controls are defined and customized based on user control parent class (e.g., System.Web.UI.UserControl), which supports user-definition of such controls. User controls are generally defined by a declaration file created by the user-developer and compiled (e.g., pre-compiled, just-in-time compiled, etc.) within the environment. In order to be available to the dynamic content resource, user controls are registered with the dynamic content resource by declaring the name of the file that defines the user control, such as by using an exemplary declaration of the form:
<%@ Register TagPrefix=“Acme” TagName=“Message” Src=“pagelet1.ascx” %>
   wherein the user-developer has defined the user control in a file named “pagelet1.ascx”). A user control, therefore, is a special type of server control that supports user definition of the control.

Other personalizable server-side controls are termed “dynamic controls”, which are not declared in a persistent format of the dynamic content resource. Instead, a dynamic control may be specified by a user (e.g., selecting a Weather application in a portal page). When a corresponding request is made to the server, the selection of the dynamic control is recorded as a personalizable property of another server-side control. Thereafter, when the associated web page is displayed at the client, the selected dynamic control is displayed in the web page, despite the lack of a declaration of the dynamic control in the dynamic content resource. In addition to the dynamic control itself being personalizable (in that its presence in the web page is persisted), the dynamic control may also have its own personalizable properties.

The dynamic content resource may also specify that the web page defined by the file and/or one or more client-side user interface elements are “personalizable”, such that properties of the server-side controls may persist across multiple requests. Personalization refers to the ability for server-side controls to save property values to persistent storage and is not necessarily limited to a user-specific data management. For example, the personalized property values may be associated with a web page (e.g., entered through the web page, designated to be used for the web page), individual controls, individual properties, and/or possibly individual users or groups of users. Personalization also refers to retrieving the property values from persistent storage (e.g., a persistent personalization datastore) when the server-side controls are instantiated in The personalized property values may also be output with the HTML data of the resulting page and sent to the client for display.

For example, a developer at an insurance company is responsible for maintaining and developing a set of forms used by agents to enter claim information. The developer had received complaints from his internal customers (e.g., insurance agents) that they are constantly re-entering the same data when filing individual claims (e.g., information about themselves, including agent code, state, branch office code, phone number, and email address) as part of the standard claim form. Ideally, certain user controls in the standard claim form should detect the identity of the user filling out the form and fill in the “personalized” data automatically.

A persistent personalization feature can be used to provide this requested functionality. A server control developer or a user control developer can explicitly designate which properties on a control are considered personalizable. Based on such designations, a web page author can use a personalizable server control or a personalizable user control by declaring such a control in the dynamic content resource. The web page author can enable any personalization features of such a control by toggling a property (such as “EnablePersonalization”) in the dynamic content resource. Thereafter, during web server processing of the dynamic content resource, the personalizable controls and properties are detected, and the personalized data for the personalizable controls and properties is retrieved from a persistent datastore of personalization data and loaded into the personalizable server-side control objects. Any new personalized data provided by the client is then loaded into the appropriate server control objects, and after processing is complete, the current/updated personalization data is stored back in the persistent personalization datastore. When the web page content is generated by the server controls, the personalized data from the datastore or the new personalized data from the client is included in the web page content that is sent back to the client for display.

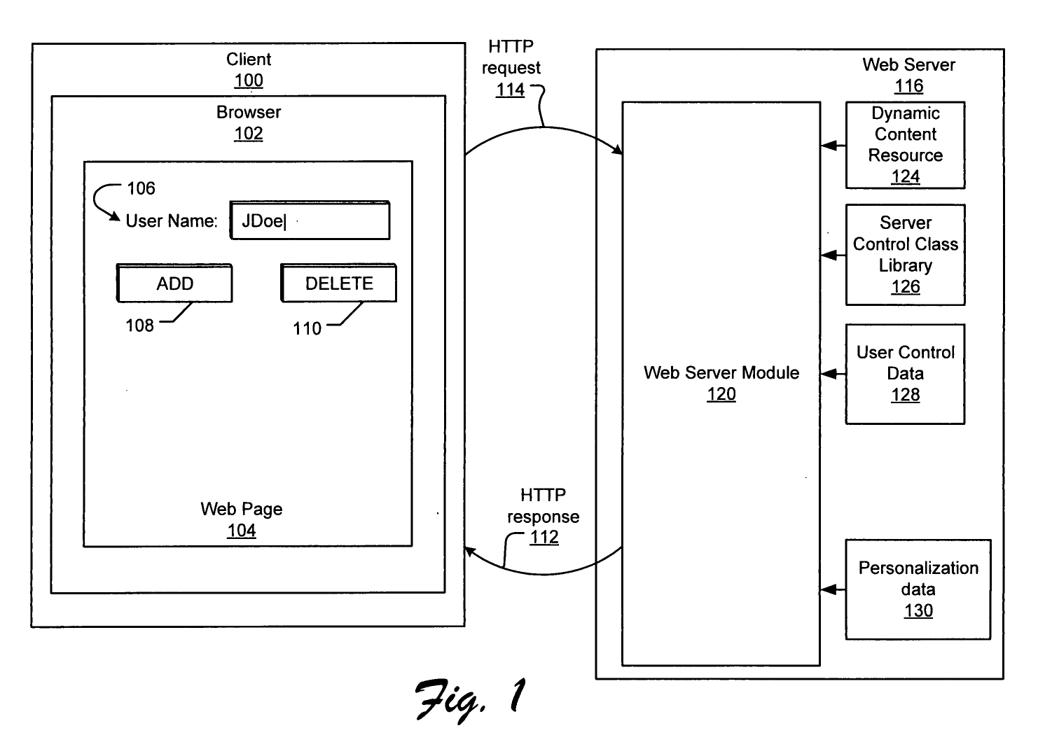

FIG. 1 illustrates an exemplary web server for dynamically generating web page content with persistent personalized data. A client 100 (e.g., a desktop computer, a mobile phone, a Personal Digital Assistant (PDA), etc.) executes a browser 102 that displays a web page 104 on a display device of the client 100. The client 100 may include a client computer system having a display device, such as a video monitor.

The exemplary web page 104 incorporates various client-side user interface elements, including a text box control 106 and two button controls 108 and 110. The browser 102 can receive HTML code in the HTTP response 112 from a web server 116 and display the web page 104 as described by the HTML code. Although HTML is described with reference to one embodiment, other authoring languages, including without limitation SGML (Standard Generalized Markup Language), XML (eXtensible Markup Language), cHTML (Compact HyperText Markup Language), XHTML (Extensible HyperText Markup Language) and WML (Wireless Markup Language), which is an XML-based markup language, designed for specifying the content and user interfaces of narrowband wireless devices, such as pagers and cellular phones, are contemplated within the scope of the present invention. The communications between the client 100 and the web server 116 may be conducted using a sequence of HTTP requests 114 and HTTP responses 112. Although HTTP is described with reference to one embodiment, other transport protocols, including without limitation HTTPS, are contemplated within the scope of the present invention.

On the web server 116, a web server module 120 receives an HTTP request 114 specifying a dynamic content resource 124 using a global address. The dynamic content resource 124 contains one or more server control declarations. Accordingly, the web server module 120 resolves the global address and processes the specified dynamic content resource 124 to generate one or more server side controls based on the declarations.

Some declarations specify compiled server controls from a server control class library 126. The declared server controls and/or public properties thereof may be marked as “personalizable”, using an exemplary format that follows although alternative implementations do not require attribution of a given server control class as “personalizable”. Line (4) declares the public class AgentData as “personalizable”, and lines (9), (15), (26), and (32) declare the class's public properties AgentCode, State, WorkPhone, and Email as “personalizable”. The public property BranchOfficeID is not declared as personalizable.

It should be understood that, in some alternative implementations, only the properties of a class, not the class itself, are attributed as “personalizable”. In contrast, in other implementations, an entire class may be attributed as “personalizable” without attributing public properties of that class, such that all public properties of the class are deemed personalizable.

| | |
|---|---|
| (1) | [namespace definitions not shown] |
| (2) | public namespace ACME.Controls { |
| (3) | |
| (4) | [Personalizable] |
| (5) | public class AgentData : WebControl { |
| (6) | |
| (7) | [additional code for server control not shown] |
| (8) | |
| (9) | [Personalizable(PersonalizationScope.User)] |
| (10) | public string AgentCode { |
| (11) | get { } |
| (12) | set { } |
| (13) | } |
| (14) | |
| (15) | [Personalizable(PersonalizationScope.Shared)] |
| (16) | public string State { |
| (17) | get { } |
| (18) | set { } |
| (19) | } |
| (20) | |
| (21) | public int BranchOfficeID { |
| (22) | get { } |
| (23) | set { } |
| (24) | } |
| (25) | |
| (26) | [Personalizable(PersonalizationScope.User)] |
| (27) | public string workPhone { |
| (28) | get { } |
| (29) | set { } |
| (30) | } |
| (31) | |
| (32) | [Personalizable(PersonalizationScope.User)] |
| (33) | public string Email { |
| (34) | get { } |
| (35) | set { } |
| (36) | } |
| (37) | |
| (38) | [additional code for server control not shown] |
| (39) | } |
| (40) | } |

Other declarations may specify user controls from a user control data store 128. The declared user controls and/or public properties thereof may be marked as “personalizable”, using an exemplary format that follows. Lines (6), (12), (23), and (29) declare a class's public properties AgentCode, State, WorkPhone, and Email as “personalizable”. The public property BranchOfficeID is not declared as personalizable. The declaration of the user control itself is not shown in the example below.

| | |
|---|---|
| (1) | <script runat=”server”> |
| (2) | |
| (3) | // User control used to collect data for insurance claim |
| (4) | // |
| (5) | |
| (6) | [Personalizable] |
| (7) | public string AgentCode { |
| (8) | get { } |
| (9) | set { } |
| (10) | } |
| (11) | |
| (12) | [Personalizable] |
| (13) | public string State { |
| (14) | get { } |
| (15) | set { } |
| (16) | } |
| (17) | |
| (18) | public int BranchOfficeID { |
| (19) | get { } |
| (20) | set { } |
| (21) | } |
| (22) | |
| (23) | [Personalizable] |
| (24) | public string workPhone { |
| (25) | get { } |
| (26) | set { } |
| (27) | } |
| (28) | |
| (29) | [Personalizable] |
| (30) | public string Email { |
| (31) | get { } |
| (32) | set { } |
| (33) | } |
| (34) | |
| (35) | [additional code for user control not shown] |
| (36) | |
| (37) | </script> |
| (38) | [additional HTMLcode and controls for user control not shown] |

Given the availability of personalizable controls, the developer can declare the use of such controls in the dynamic content resource 124. The declarations in the dynamic content resource 124 are annotated so as to enable personalization of one or more properties of one or more of the server-side controls that correspond to the client-side user interface elements. For example, for a compiled server control, a dynamic content resource may include exemplary declarations as follows:

| | |
|---|---|
| (1) | <%@ Register TagPrefix=“ACME” |
| | Namespace=“ACME.Controls” |
| (2) | Assembly=“ACME.Controls”%> |
| (3) | |
| (4) | [additional code not shown] |
| (5) | |
| (6) | <asp:webpartmanager id=“WebPartManager1” |
| | runat=“server”> |
| (7) | </asp:webpartmanager> |
| (8) | |
| (9) | <asp:webpartzone id=“WebPartZone1” runat=“server”> |
| (10) | <zonetemplate> |
| (11) | <ACME:AgentData runat=“server” id=“agentdata11”> |
| (12) | </ACME:AgentData> |
| (13) | </zonetemplate> |
| (14) | </asp:webpartzone> |

The registration of the server control is shown in lines 1-2. The declaration of a personalization manager (i.e., WebPartManager1) in lines 6 and 7 and the declaration of the AgentData control within the WebPartZone1 allow the user to participate in personalization.

In contrast, for a user control, a dynamic content resource may include exemplary declarations as follows:

| | |
|---|---|
| (1) | <%@ Register TagPrefix=“ACME” TagName=“AgentData” |
| (2) | Src=“˜/UserControls/AgentData.ascx”%> |
| (3) | |
| (4) | [additional code not shown] |
| (5) | |
| (6) | <asp:webpartmanager id=“WebPartManager1” runat=“server”> |
| (7) | </asp:webpartmanager> |
| (8) | |
| (9) | <asp:webpartzone id=“WebPartZone1” runat=“server”> |
| (10) | <zonetemplate> |
| (11) | <ACME:AgentData runat=“server” id=“agentdata11”> |
| (12) | </ACME:AgentData> |
| (13) | </zonetemplate> |
| (14) | </asp:webpartzone> |

The registration of the server control is shown in lines 1-2. The declaration of a personalization manager (i.e., WebPartManager1) in lines 6 and 7 and the declaration of the AgentData control within the WebPartZone1 allow the user to participate in personalization.

Given the personalizable server-side controls defined in the server control class library 126 and the user control datastore 126, the dynamic content resource 124 declares a personalization manager (not shown), which among other functions, manages the personalization of controls and properties through one or more provider modules. The personalization manager can retrieve configuration data from a configuration file (not shown). Exemplary configuration data may include without limitation identification of various personalization provider modules and various authorization parameters. The personalization manager can also call methods in a personalization instance (not shown), which determines the personalization capabilities of the user, reads and writes to the personalization datastore 130 through a provider module, and manages a personalization state object (not shown).

The dynamic content resource 124 also declares a zone object (e.g., a WebPartZone), which is managed by the personalization manager. The zone object generally contains the personalizable control objects of the page, although some personalizable control objects may also reside outside of the zone object (e.g., the personalization manager or dynamic controls). When processing the dynamic content resource 124, the page factory 120 instantiates a declared server-side control, retrieves appropriate personalization data from the personalization datastore 130 through the personalization instance and loads the personalization data into the server-side control objects. In this manner, the state of the personalizable server-side controls is initiated to reflect the persistent personalization data.

The previous examples of personalizable control definition have involved public properties of the server-side controls. However, in some circumstances, a developer may desire personalization of only a portion of a property value (e.g. a portion of a table) or of an internal variable that is never exposed publicly. In such circumstances, an IPersonalizable interface may be employed to provide personalization of server control data. The framework is similar to that of the server control example discussed above. In addition, the server control in this configuration exposes an IPersonalizable interface, which allows the control to manage properties that are not marked with the [Personalizable] attribute.

In the definition that follows, the AgentData control class is designated as personalizable, as is the Email property. However, the NetworkID property is private and, therefore, is not made automatically personalizable by use of the [Personalizable] tag. Instead, the IPersonalizable interface is employed.

| | |
|---|---|
| (1) | [namespace definitions not shown] |
| (2) | public namespace ACME.Controls { |
| (3) | |
| (4) | [Personalizable] |
| (5) | public class AgentData : WebControl, IPersonalizable { |
| (6) | |
| (7) | [additional code for control not shown] |
| (8) | |
| (9) | IDictionary personalizationInfo=null; |
| (10) | |
| (11) | [Personalizable] |
| (12) | public string Email { |
| (13) | get { } |
| (14) | set { } |
| (15) | } |
| (16) | |
| (17) | // NetworkID is a private property and thus is not |
| (18) | // automatically managed by the Web Parts control set |
| (19) | // and personalization feature. |
| (20) | // |
| (21) | private string NetworkID { |
| (22) | get { } |
| (23) | } |
| (24) | |
| (25) | // |
| (26) | // IPersonalizable implementation |
| (27) | // |
| (28) | bool IPersonalizable.Load( |
| (29) | IDictionary sharedState, |
| (30) | IDictionary userState) |
| (31) | { |
| (32) | // Load value for NetworkID here using the |
| (33) | // provided dictionary |
| (34) | } |
| (35) | void IPersonalizable.Save( |
| (36) | IDictionary state) |
| (37) | { |
| (38) | // Save value for NetworkID here by writing |
| (39) | // a name-value pair into the dictionary |
| (40) | } |
| (41) | |
| (42) | [additional code for server control not shown] |
| (43) | |
| (44) | } |
| (45) | } |

The IPersonalizable interface, when implemented, allows a developer to control the reading of personalization data from an underlying personalization data store 130 (or “dictionary”) and the storing of the personalization to the personalization data store. Accordingly, the IPersonalizable interface is particularly useful for properties or data that:
1. are not public
2. have only a get{ } implementation or only a set{ } implementation
3. exist in a database, but no longer exist on the control (unknown data)
4. are cached using custom caching mechanisms

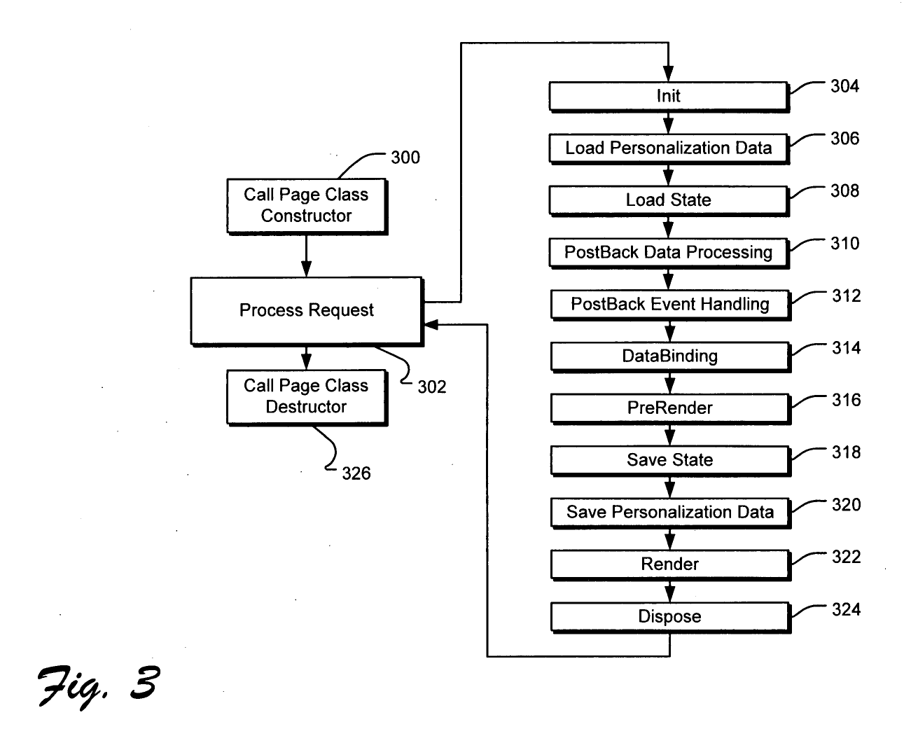

The Load( ) and Save( ) method of the IPersonalizable interface are called automatically during the life of the control (see the description of FIG. 3). Methods on the IPersonalizable interface participate in the control life cycle in a similar manner as the ViewState features, which are described in more detail in U.S. patent application Ser. No. 09/574,144, entitled “State Management of Server-side Control Objects” and incorporated herein by reference for all that it discloses and teaches.

It should also be understood that, in some implementations, the personalization manger may be made personalizable by implementing the IPersonalizable interface. The personalization manager may persist its own personalization data, such as the type and identifiers of dynamic server-side controls added to the page, the position and other state information about the controls on the page, the dynamic connections added to the page, and the state of the connections on the page, types and properties of customized zones, etc. In this manner, the personalization manager can initialize its state or customize itself with such persistent data through the IPersonalizable interface (e.g., the personalization manager can store its own metadata in a persistent datastore through the IPersonalizable interface).

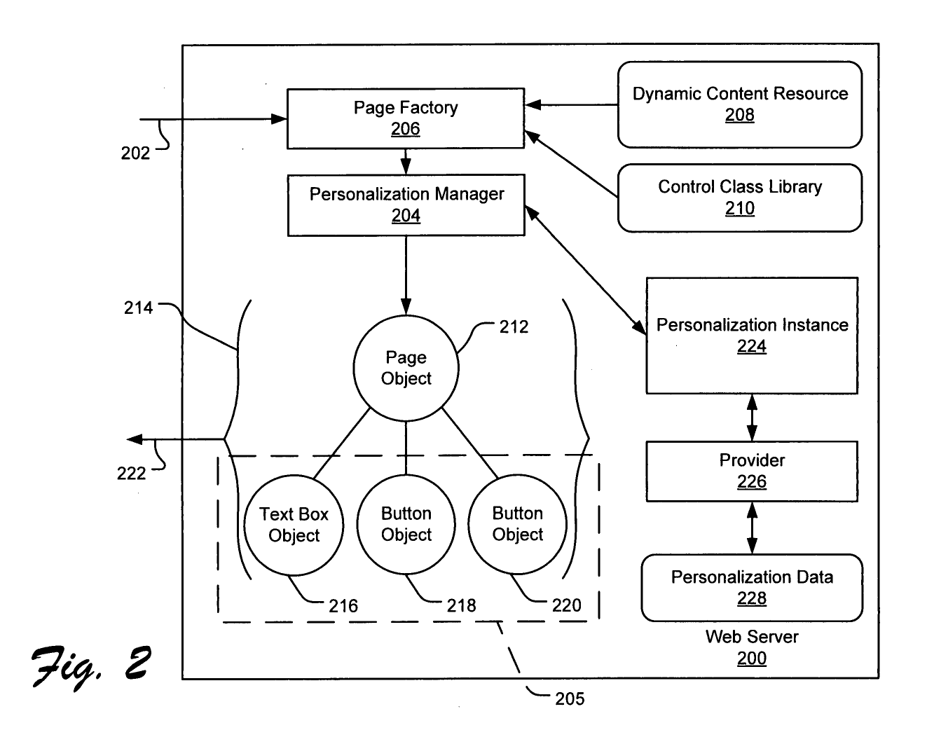

FIG. 2 illustrates exemplary modules supporting web page personalization in a web server 200. The web server 200 receives an HTTP request 202 and includes various modules for processing the request 202, including without limitation an HTTP pipeline and modules for logging of web page statistics, user authentication, user authorization, and output caching of web pages. Each incoming HTTP request 202 received by the web server 200 is ultimately processed by a specific instance of an IHttpHandler class (not shown), which resolves the URL request and invokes an appropriate handler factory (e.g., a page factory module 206). The request 202 specifies a dynamic content resource 208, which declares the server-side controls associated with the web page and the personalizable attributes thereof, if any.

In FIG. 2, the page factory module 206 associated with the dynamic content resource 208 is invoked to handle the instantiation and configuration of the objects declared in the specified dynamic content resource 208. When a request for the dynamic content resource 208 is first received by the page factory module 206, the page factory module 206 searches the file system for the appropriate file. The file may contain text (e.g., authoring language data) or data in another format (e.g., bytecode data or encoded data) that may later be interpreted or accessed by the server to service the request. If the physical file exists, the page factory module 206 opens the file and reads the file into memory.

After reading the dynamic content resource 208 into memory, declaration of a personalization manager 204 is detected within the dynamic content resource 208. Accordingly, the personalization manager 204 is instantiated by the page factor 206 in support of personalization and other web server functions. Likewise, declaration of a zone object 205 is detected within the dynamic content resource 208. Accordingly, the zone object 205 is instantiated and is managed by the personalization manager 204. The zone object 205 contains the personalizable controls that are declared in the dynamic content resource 208. There can be multiple zone objects for a given web page, some containing personalizable controls, and others containing non-personalizable controls.

Declaration of a page control 212 is also detected within the dynamic content resource 208. Therefore, a page factory module 206 processes the file content to build a data model of the page (e.g., lists of script blocks, directives, static text regions, hierarchical server-side control objects, server-side control properties, etc.). The data model is used to generate a source listing of a new object class. A control class library 210 or a user class datastore (not shown) may be accessed by the page factory module 206 to obtain predefined server-side control classes used in the generation of the control object hierarchy.

The page factory module 208 instantiates the page control 212, which is a server-side control object that corresponds to the web page 104 of FIG. 1. The page object 212 may be instantiated as the top level of the control object hierarchy 214. A page object 212 typically contains in a hierarchy one or more child control objects, and each child control object can contain one or more child control objects of its own to extend into a hierarchy of multiple levels. The text box object 216 corresponds to the text box 106 in FIG. 1. Likewise, the button object 218 corresponds to the add button 108 in FIG. 1, and the button object 220 corresponds to the delete button 110 in FIG. 1. The page object 212 is hierarchically related to other control objects on the server.

The page object 212 and descendent control objects execute a sequence of operations to process and generate the web content that corresponds to client-side user interface elements. The page object 212 and its children comprise an exemplary control object hierarchy 214. In one embodiment, a page object is a container object that hierarchically contains its children control objects. In an alternative embodiment, other forms of hierarchical relation may be employed, including a dependency relationship. In a more complex control object hierarchy with multiple levels of children, a child object can be a container object for other child objects. Other exemplary control objects and hierarchies are also contemplated.

In the illustrated implementation, the control objects in the control object hierarchy 214 are created and executed on the server 200, and each server-side control object “mirrors” a corresponding user interface element on the client. The server-side control objects also cooperate to handle input from the HTTP request 202, to manage the states of server-side control objects, to perform data binding with server-side databases, and to generate authoring language data (e.g., HTML code) used to display a resulting web page at a client. The resulting authoring language data is generated (i.e., rendered) from the server-side control object hierarchy 214 and transmitted to the client in an HTTP response 224. For example, resulting HTML code may embody any valid HTML construct and may reference ACTIVEX-type controls, JAVA applets, scripts, and any other web resources that yield client-side user interface elements (e.g., control buttons, text boxes, etc.) when processed by a browser.

Certain of the server-side controls in hierarchy 214 may be designated as “personalizable”. During the initialization phase of the personalization manager 204, a personalization instance 224 is created, which instantiates a provider module 226. The provider module 226 may be a default provider or a provider associated specifically with the dynamic content resource requested and well as with other possible resources). The provider module 226 extracts personalization data from the persistent datastore 228 and passes the personalization data in a personalization state object to the personalization instance 224, which loads the personalization data into the appropriate server-side controls through the personalization manager 204. Likewise, at the end of the server-side control lifecycle, the personalization manager 204, the personalization instance 224, and a personalization state object are used to extract the personalization data from the server-side controls and store the personalization data into the persistent datastore 228 through the provider 226.

Personalization data can be applied for different sets of users. Some personalization data is applicable only to a specific user and control on a page. Other personalization data is applicable to all users who visit a site. Personalization “scope” is used to manage which set of data should be retrieved and displayed to the user. The web page server 204 can execute in a “shared” scope or a “user” scope. One type of scope is termed “shared personalization scope”, which indicates that the personalization data of a given control should be loaded for all users viewing the control (i.e., visiting a web page incorporating the server-side control). The shared scope is commonly used by a web site developer or administrator setting properties across multiple users. For example, an insurance company intranet administrator at a regional office deploys the latest standard claim form. In order to personalize the form for the regional office, the administrator configures persistent data in the personalized datastore 228, such as the address, fax number and phone number of the office, etc. Shared data can be loaded for the user but can only be saved or altered by the user if the user has necessary rights.

In contrast, another type of scope, termed “user personalization scope” indicates that the personalization data of a given control can be loaded for and saved by the web site developer or administrator as well as an individual user associated with the data. Data in the shared personalization scope can still be loaded for the user, but cannot be saved/altered by the user (unless that user has necessary administrator rights). In user personalization scope, individual users may introduce persistent customizable data in the personalized data store 230, such as their names, direct dial phone numbers, agent codes, etc. This personalized data will persist in the personalization data store 228, awaiting a subsequent visit to the web site by the user.

FIG. 3 illustrates a process flow diagram representing server-side processing of an exemplary page object and other control objects. In the illustrated implementation, it is assumed that the personalization manager, the personalization instance, and the personalization provider have already been created.

In operation 300, a page object constructor is called by the page factory. As a result, a page object is created to “mirror” the web page user interface element on the client. In operation 302, the page factory module calls the ProcessRequest member function of the page object, which initiates the staged operations for processing the HTTP request received from a client. In a first stage, a server-side Create Operation (not shown) may create the descendant server-side control objects contained in the control object hierarchy of the page object, that is, constructors for child control objects are recursively called to create the control objects during the lifetime of the processing of the HTTP request processing. In alternative implementations, creation of some server side control objects may be deferred until needed.

In response to the server call to the page object's ProcessRequest method, operations 304 through 324 may be executed by the page object and by individual descendant control objects, depending in part on the data of a given HTTP request. In one implementation, the operations 304-324 are performed for each individual object in the order illustrated in FIG. 3; however, a given operation for one object may occur out of order or not at all with respect to a given operation of another object, depending on the HTTP request. The order of operation processing by the page object and the descendent control objects depends on various factors, including without limitation the nature of the data in the HTTP request, the configuration of the control object hierarchy, the current state of the control objects, and whether deferred control object creation is implemented.

The Init operation 304 initializes a control object after it is created by executing any server-side code associated with initialization in the dynamic content file. In this manner, each server-side control object may be customized with specific server-side functionality that is declared in the dynamic content file. In one implementation, dynamic content code intended to customize or extend the base page control classes as declared by the page developer in the dynamic content resource on the server.

A Load operation 306 retrieves personalization state and personalization data for any personalizable server-side controls and properties from a persistent personalization datastore and loads the personalization data into the appropriate server-side control object. The Load operation 306 determines an initial scope of the personalization based on currently available information (e.g., identity of the user, authentication of the user, authorization of the user, previous state of the page, current state of the page, etc.). The result of the state determination is stored in a CurrentScope property of the personalization instance. The Load operation 306 also deserializes the personalization data stored in an underlying personalization datastore and loads the personalization data into a personalization state object. Each server-side control object is associated with a hierarchical object identifier (ID) so that the provider can load the personalization data into the correct objects. The provide traverses through each personalizable object, determines whether personalizable data exists for the object, and loads personalization data into the object, as appropriate, based on the current scope.

State management of the server-side control objects is supported in another Load operation 308 and in a Save operation 320, which use a transportable state structure to accommodate the stateless model for client server systems by restoring server-side control objects to their previous states. The state management feature is distinct from the personalization (state) feature, although the two features interact. State management generally refers to maintaining the “view state” of the control in anticipation of a subsequent request to the same page in the same client session (e.g., a contiguous client-server dialogue). In contrast, personalization generally refers to maintaining and managing persistent data in association with a user and/or a control across multiple client sessions.

In one implementation, the state is communicated to and from the server in one or more hidden HTML fields of an HTTP request/response pair, although other transportable state structures are contemplated, including cookies and visible fields. In a given sequence of requests and responses relating to the current page between a client and a server, the states of one or more control objects are recorded into a transportable state structure by the Save operation 320 after the processing of a previous request. Additional state information may also be included in the transportable state structure, including hierarchical information or control object identifiers to allow the server to associate a given view state with the appropriate control object. In a subsequent HTTP request, the state information is returned to the server in the transportable state structure. The server extracts the view state information from the received transportable state structure and loads (in a Load operation 308) the state data into the appropriate control objects within the control object hierarchy to restore each control object to its state as it existed prior to a previous HTTP response. After the current request is processed, the view states of one or more server-side control objects are again recorded into the transportable state structure by the Save operation 320, and the transportable state structure is returned to the client in the next HTTP response.

As a result of the Load operations 306 and 308, each server-side control object is placed in a state consistent with its state prior to a previous HTTP response. The Load operation 306 restores the personalizable properties of personalizable controls with the appropriate personalization data, and the Load operation 308 restores the non-personalizable control objects to their previous view states. Generally, the Load operations 306 and 308 operate on different properties of server-side controls. However, a developer may alternatively choose to manage the state of a personalizable property using both the transportable state structure and the personalization datastore.

In postback data operation 310, postback data received from the HTTP request is processed. Postback data may be included in the payload of the HTTP request in key-value pairs, in a hierarchical representation (e.g., XML), or in other data representations, such as RDF (“Resource Description Framework”). Postback data operation 310 parses the payload to identify a unique identifier of a server-side control object. If the identifier (e.g. “page1:text1”) is found and the identified server-side control object exists in the control object hierarchy, the corresponding postback data is passed to the control object. Postback data operation 310 parses the payload of the HTTP request and obtains the unique identifier of the textbox and its associated value (i.e., “JDoe”). Postback data operation 310 then resolves the unique identifier of the textbox to identify the corresponding server-side control object and passes the “JDoe” value to the object for processing.

As discussed with regard to the Load operation 308, the property values of server-side control objects may be restored to their previous states. In response to the receipt of postback data, the server-side control object determines whether the passed-in postback value causes a change from the corresponding property's previous value. If so, the change is logged in a change list to indicate a data change for the associated control object. After all postback data has been processed within the control object hierarchy, a call may be made to a control object method to raise one or more postback data changed events to one or more non-user-interface server components, such as a stock price look-up application running on the server. An example of a postback data changed event is an event indicating that postback data has caused a property of a server-side control object to change. In an exemplary implementation, such an event can be sent to a system-provided event queue so that a server component that is registered to process the event may be invoked. In this manner, a server-side non-user-interface server component can respond to events triggered by a change in data of a server-side control object. Alternative methods of implementing events are also contemplated in the scope of the present invention, including using application-provided event queues, polling, and processing interrupts.

The postback data operation 310 also provides a mechanism for introducing new personalization data into the environment. For example, a user may alter his or her new phone number into a personalizable input field of a form in a web page. The new phone number is sent to the server in postback data and is loaded into the personalizable property of the appropriate server-side control object.

In operation 312, postback events are handled. Postback events are communicated in the payload of the HTTP request. Operation 312 parses a specified event target (e.g., labeled “_EVENTTARGET” in an embodiment of the present invention) identifying the server-side control object to which the event is directed. Furthermore, operation 312 parses the located event arguments, if any, and provides the event argument (e.g., labeled “_EVENTARGUMENT” in an embodiment of the present invention) to the specified server-side control object. The control object raises its events for processing by the non-user-interface server component (e.g., a server-side stock price look-up application) associated with the dynamic content file.

Operation 314 resolves data binding between the server-side control objects and one or more databases accessible by the server. In an embodiment o the present invention, properties of server-side control objects may be associated (or data bound) to properties of a parent data binding container, such as a table in a server-side application database. During the data binding operation 314, the page framework may update a data bound control object property with the value of the corresponding parent data binding container property. In this manner, user interface elements on the web page of the next response accurately reflect updated property values, because the control object properties to which the user interface elements correspond have been automatically updated during the data binding operation 314. Likewise, control object properties can also be updated to the parent data binding container fields, thereby updating a server-side application database with postback input from a server-side control object. Operation 316 performs miscellaneous update operations that may be executed before the control object state is saved and the output is rendered.

Another Save operation 318 requests view state information from one or more control objects in the control object hierarchy and stores the view state information for insertion into a transportable state structure that is communicated to the client in the HTTP response payload. For example, a “grid” control object may save a current index page of a list of values so that the “grid” control object may be restored to this state after a subsequent HTTP request (i.e., in operation 308). As described above, the view state information represents the state of the control object hierarchy prior to any subsequent actions by the client (e.g., before the HTTP response is sent to the client). When the view state information is returned, it will be used to place the control object hierarchy in that previous state prior to processing any client postback input or databinding.

A Save operation 320 saves the personalization data from each personalizable server-side control object and property into the personalization state object. Any differences between the existing personalization data and the values currently stored in each server-side control object are detected (e.g., by an IsDirty property that reflects changes in IPersonalization data) and only the differences are written to the personalization datastore. In the prior example of a new phone number being entered by a user into a personalizable field of a web page form, the new phone number will be identified as “changed” and will therefore be saved back into the persistent data store in the save operation 318. The next time the user access the web page, the personalization manager and the personalization instance will populate the phone number property of the appropriate server-side control object with the newly persistent phone number from the datastore.

The render operation 322 generates the appropriate authoring language output (e.g., HTML data) for communication to the client in an HTTP response. Rendering is accomplished through a top-down hierarchical tree walk of all server-side control objects and embedded rendering code. Operation 324 performs any final cleanup work (e.g., closing files or database connections) before the control object hierarchy is terminated. Processing then returns to operation 302 and proceeds to operation 326 where the page object is terminated.

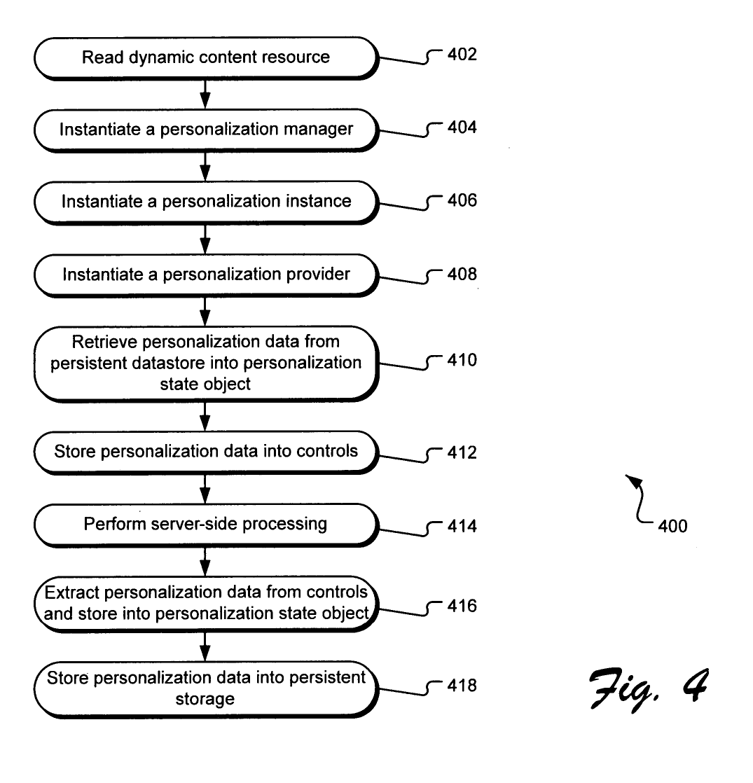

FIG. 4 illustrates exemplary operations 400 for personalizing server-side controls. The operations 400 illustrate the application of personalization data to server-side control objects and the saving of personalization data into a persistent personalization datastore.

A reading operation 402 reads the dynamic content file and detects declaration of a personalization manager, a zone object, a page control, and assorted server controls. A creation operation 404 instantiates the personalization manager and the zone object. The zone object contains (or will contain) any personalizable server-side control objects. The personalization manager can then manage the personalizable server-side control objects through the zone object.

Another creation operation 406 instantiates a personalization instance, which instantiates a provider in another creation operation 408. The personalization instance also determines the user capabilities and sets the initial scope for the personalization manager. A loading operation 410 instantiates a personalization state object, extracts the personalization data from a persistent personalization datastore, deserializes the personalization data, and loads the personalization data into the personalization state object.

The personalization data stored by the personalization state object is associated with individual controls and/or individual users. Depending on who the user is, what rights the user has, and which control is at issue, the personalization instance can select different values of personalization data from the personalization state object for loading into the server-side control object hierarchy.

A storing operation 412 traverses through the server-side control object hierarchy evaluating personalizable objects and properties (and user capabilities, when appropriate), searching for corresponding personalization data in the personalization state object, and loading such personalization data into the objects and properties. If no personalization data is found to correspond to a personalizable object or property, as influenced by personalization scope and user capabilities, no data is loaded for that object or property.

A processing operation 414 performs standard server-side control processing (e.g., operations 308-318 in FIG. 3). Values of personalizable properties may change during this processing. For example, the user may have sent a new phone number as postback data in the HTTP request. As such, during the postback data processing operation 310 of FIG. 3, the value of the personalizable property changes during the processing operation 414. As such, a storing operation 416 extracts changed personalization data from the server-side controls in the control object hierarchy and stores the changed data into the personalization state object. Upon conclusion of server-side processing of the request, the personalization data in the personalization state object is serialized and stored by the personalization instance in the persistent personalization datastore in a storing operation 418.

As discussed with regard to FIG. 3, the server-side control objects generate authoring language data for transmission to the client. With this data, the client can display a resulting web page containing personalized data retrieved from the persistent personalization datatore. In one implementation, a result of these operations is the persisting of “view state”-like data over multiple browsing sessions.

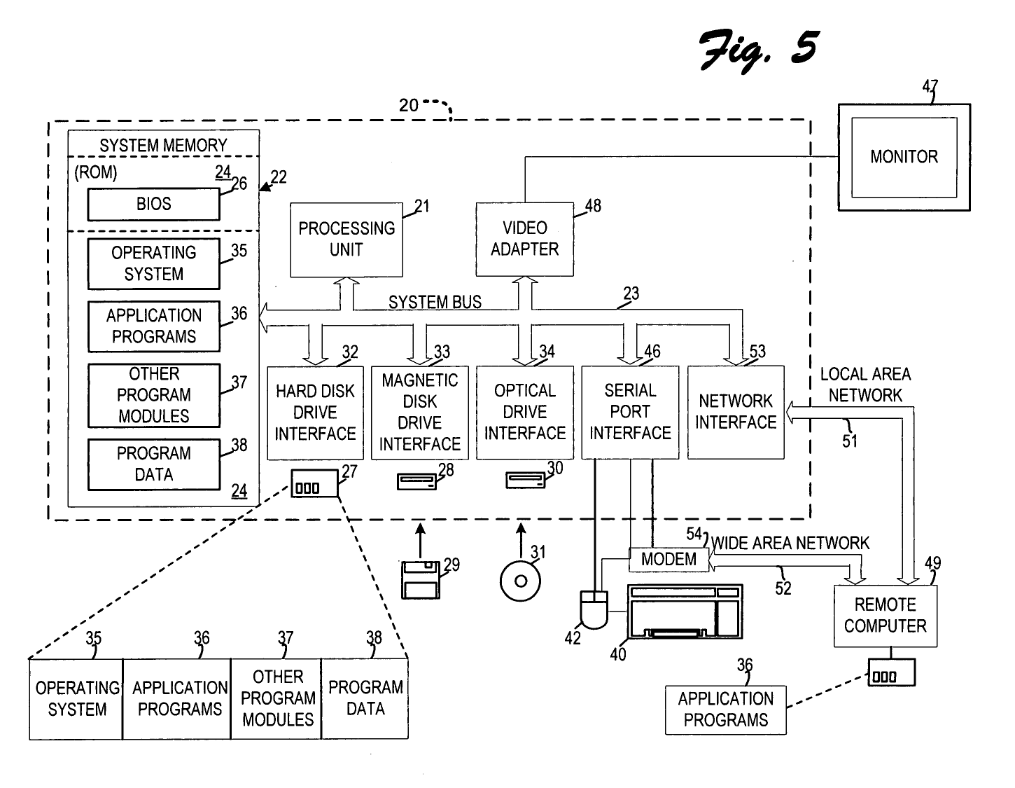

The exemplary hardware and operating environment of FIG. 5 for implementing the invention includes a general purpose computing device in the form of a computer 20, including a processing unit 21, a system memory 22, and a system bus 23 that operatively couples various system components include the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 6. The logical connections depicted in FIG. 6 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

In an exemplary implementation, a web server module, a zone object, a personalization instance, a page factory module, assorted control objects, a personalization provider module, server controls, user controls, and other modules may be incorporated as part of the operating system 35, application programs 36, or other program modules 37. Personalization data, user capabilities, view state data, dynamic content resources, and other data may be stored as program data 38.

Furthermore, the described technologies are applicable outside of a web server framework, such that any user interface framework can benefit from personalization or customization using persisted data using a hierarchy of control objects. As such, a web server in the described implementations may be replaced with a user interface server module or process. Likewise, a web client of the described implementations may be replaced with a user interface module or process. For example, the user interface server and client may be individual processes within a user interface framework of an individual workstation.

The embodiments of the invention described herein are implemented as logical steps in one or more computer systems. The logical operations of the present invention are implemented (1) as a sequence of processor-implemented steps executing in one or more computer systems and (2) as interconnected machine modules within one or more computer systems. The implementation is a matter of choice, dependent on the performance requirements of the computer system implementing the invention. Accordingly, the logical operations making up the embodiments of the invention described herein are referred to variously as operations, steps, objects, or modules.

The above specification, examples and data provide a complete description of the structure and use of exemplary embodiments of the invention. Since many embodiments of the invention can be made without departing from the spirit and scope of the invention, the invention resides in the claims hereinafter appended.

What is claimed is:

1. A method of personalizing a web page using a server-side control at a web server responsive to a receipt of a request from a client, the request specifying a dynamic content resource containing a declaration of the server-side control, the method comprising:
extracting from a persistent personalization datastore personalization data associated with the server-side control;
creating the server-side control at the web server based on the declaration;
loading the personalization data into the server-side control; and
generating from the server-side control authoring language data defining the personalized web page that includes the personalization data associated with the server-side control.

2. The method of claim 1 further comprising:
determining a personalization scope of the web server based on the dynamic content resource.

3. The method of claim 1 further comprising:
determining a personalization scope of the web server based on the dynamic content resource and an identity of a user who sent the request.

4. The method of claim 1 wherein the personalization data is stored in a personalization state responsive to the extracting operation, and the loading operation comprises:
extracting personalization data associated with the server side control from the personalization state; and
loading the extracted personalization data associated with the server-side control into the server-side control.

5. The method of claim 4 wherein the web server has a shared personalization scope.

6. The method of claim 4 wherein the web server has a user personalization scope.

7. The method of claim 1 wherein the request is associated with a user, the personalization data is stored in a personalization state responsive to the extracting operation, and the loading operation comprises:
extracting personalization data associated with the user and the server side control from the personalization state; and
loading the extracted personalization data associated with the user and the server-side control into the server-side control, if the web server has a user personalization scope.

8. The method of claim 1 wherein the extracting operation comprises:
deserializing the personalization data extracted from the persistent personalization datastore; and
storing the deserialized data into a personalization state object in association with one or more server-side control identifiers.

9. The method of claim 8 wherein the storing operation comprises:
storing the deserialized data into the personalization state object in association with one or more server-side control identifiers and one or more user identities.

10. The method of claim 1 further comprising:
sending the authoring language data defining the personalized web page to the client.

11. A computer program product encoding a computer program for personalizing a user interface page using a server-side control of a user interface server responsive to a receipt of a request from a client, the request specifying a dynamic content resource containing a declaration of the server-side control, the computer process comprising:
creating the server-side control of the user interface server based on the declaration;
loading the personalization data from a persistent personalization datastore into the server-side control; and
generating from the server-side control authoring language data defining the personalized user interface page that includes the personalization data associated with the server-side control.

12. The computer program product of claim 11 wherein the computer process further comprises:
determining a personalization scope of the user interface server based on the dynamic content resource.

13. The computer program product of claim 11 wherein the computer process further comprises:
determining a personalization scope of the user interface server based on the dynamic content resource and an identity of a user who sent the request.

14. The computer program product of claim 11 wherein the personalization data is stored in a personalization state responsive to the extracting operation, and the loading operation comprises:
extracting personalization data associated with the server side control from the personalization state; and
loading the extracted personalization data associated with the server-side control into the server-side control.

15. The computer program product of claim 14 wherein the user interface server has a shared personalization scope.

16. The computer program product of claim 14 wherein the user interface server has a user personalization scope.

17. The computer program product of claim 111 wherein the request is associated with a user, the personalization data is stored in a personalization state responsive to the extracting operation, and the loading operation comprises:
extracting personalization data associated with the user and the server side control from the personalization state; and
loading the extracted personalization data associated with the user and the server-side control into the server-side control, if the user interface server has a user personalization scope.

18. The computer program product of claim 11 wherein the extracting operation comprises:
deserializing the personalization data extracted from the persistent personalization datastore; and
storing the deserialized data into a personalization state object in association with one or more server-side control identifiers.

19. The computer program product of claim 18 wherein the storing operation comprises:
storing the deserialized data into the personalization state object in association with one or more server-side control identifiers and one or more user identities.

20. The computer program product of claim 11 further comprising:
sending the authoring language data defining the personalized user interface page to the client.

21. The computer program product of claim 11 further comprising:
extracting personalization manager data from the persistent personalization datastore to initialize a state of the personalization module, wherein the personalization manager manages personalization of server-side controls and properties; and
loading the personalization data into at least one property of the personalization manager.

22. The computer program product of claim 11 wherein the server-side control contains a personalizable property identifying a dynamically added control.

23. A method of personalizing a web page using a server-side control at a web server responsive to a receipt of a request from a client, the request specifying a dynamic content resource containing a declaration of the server-side control, the method comprising:
creating the server-side control at the web server based on the declaration;
loading client-provided data extracted from the request into a personalizable property of the server-side control;
storing the client-side data from the personalizable property into a persistent personalization datastore in association with an identifier of the server-side control, the personalization datastore being associated with the dynamic content resource; and
generating from the server-side control authoring language data defining a personalized web page that includes the client-provided data.

24. The method of claim 23 further comprising:
determining a personalization scope of the web server based on the dynamic content resource.

25. The method of claim 23 further comprising:
determining a personalization scope of the web server based on the dynamic content resource and an identity of a user who sent the request.

26. The method of claim 23 wherein a personalization state object exists to store the personalization data and the storing operation comprises:
extracting the client-provided data from the personalizable property of the server side control; and
loading the extracted client-provided data into the personalization state object.

27. The method of claim 26 wherein the web server has a shared personalization scope.

28. The method of claim 26 wherein the web server has a user personalization scope.

29. The method of claim 23 wherein the storing operation further comprises:
serializing the client-provided data extracted from the personalizable property of the server side control; and
storing the serialized client-provided data into the persistent personalization datastore.

30. The method of claim 23 further comprising:
sending the authoring language data defining the personalized web page to the client.

31. A computer program product encoding a computer program for personalizing a user interface page using a server-side control of a user interface server responsive to a receipt of a request from a client, the request specifying a dynamic content resource containing a declaration of the server-side control, the computer process comprising:
creating the server-side control of a user interface server based on the declaration;
loading client-provided data extracted from the request into a personalizable property of the server-side control;
storing the client-side data from the personalizable property into a persistent personalization datastore; and
generating from the server-side control authoring language data defining a personalized user interface page that includes the client-provided data.

32. The computer program product of claim 31 wherein the computer process further comprises:
determining a personalization scope of the user interface server based on the dynamic content resource.

33. The computer program product of claim 31 wherein the computer process further comprises:
determining a personalization scope of the user interface server based on the dynamic content resource and an identity of a user who sent the request.

34. The computer program product of claim 31 wherein a personalization state object exists to store the personalization data and the storing operation comprises:
extracting the client-provided data from the personalizable property of the server side control; and
loading the extracted client-provided data into the personalization state object.

35. The computer program product of claim 34 wherein the user interface server has a shared personalization scope.

36. The computer program product of claim 34 wherein the user interface server has a user personalization scope.

37. The computer program product of claim 31 wherein the storing operation further comprises:
serializing the client-provided data extracted from the personalizable property of the server side control; and
storing the serialized client-provided data into the persistent personalization datastore.

38. The computer program product of claim 31 further comprising:
extracting personalization manager data from the persistent personalization datastore to initialize a state of the personalization module, wherein the personalization manager manages personalization of server-side controls and properties; and
loading the personalization data into at least one property of the personalization manager.

39. The computer program product of claim 31 wherein the server-side control contains a personalizable property identifying a dynamically added control.

40. A web server for personalizing a web page using a server-side control at a web server responsive to a receipt of a request from a client, the request specifying a dynamic content resource containing a declaration of the server-side control, the web server comprising:
a provider module that extracts from a persistent personalization datastore personalization data associated with the server-side control;
a page factory that instantiates the server-side control at the web server based on the declaration;
a personalization loading module that loads the personalization data into the server-side control; and
a rendering module that generates from the server-side control authoring language data defining the personalized web page that includes the personalization data associated with the server-side control.
